(19) United States
(12) Patent Application Publication
(10) Pub. No.: US 2015/0347991 A1
(43) Pub. Date: Dec. 3, 2015

(54) METHOD AND SYSTEM FOR ANALYSIS OF CARD-ISSUED AGENCY ENTITLEMENT BENEFITS

(71) Applicant: MasterCard International Incorporated, Purchase, NY (US)

(72) Inventors: Kenny UNSER, Fairfield, CT (US); Nikhil MALGATTI, Stamford, CT (US); Serge BERNARD, Danbury, CT (US)

(73) Assignee: MasterCard International Incorporated, Purchase, NY (US)

(21) Appl. No.: 14/288,866

(22) Filed: May 28, 2014

(51) Int. Cl. G06Q 20/10

(52) U.S. Cl. CPC G06Q 20/10

(57) ABSTRACT

A method for identifying agency entitlements includes: storing a plurality of transaction data entries, each entry including data related to a payment transaction including a specific account identifier associated with a payment account involved in the transaction and transaction data; storing a plurality of account profiles, each profile including data related to a payment account including an account identifier associated with the account and account data; identifying entitlement rules, wherein each o entitlement rule is associated with an agency entitlement and is configured to identify recipients of the entitlement; applying, to account profiles, the entitlement rules to (i) the account identifier and/or account data included in the respective profile, and/or (ii) the transaction data included in transaction data entries associated with the respective account profile, to identify an agency entitlement associated with the account; and updating account profiles to include the identified entitlement associated with the account.

### FIELD

The present disclosure relates to the identification of agency entitlements, specifically the identification of accounts associated with payment cards that are funded via agency entitlements, such as government-issued benefits.

### BACKGROUND

Various types of agencies, particularly government agencies, provide benefits, such as unemployment, welfare, social security, disability, and more. For some agencies, the number of recipients of benefits can exceed tens of millions. As a result, providing benefits in the form of checks that are distributed to recipients can require a significant amount of time and resources to process. If benefits are recurring, such as regular disbursements to recipients every two weeks or every month, the expenditure of time and resources in producing and distributing these checks can be staggering for some agencies.

In order to lower the cost of disbursement of benefits, some agencies have begun to use reloadable payment cards. In such a system, the agency may distribute a reloadable payment card to a recipient once, and then add additional funds to the payment card each time new benefits are to be provided. The recipient is able to receive their benefits faster than waiting on a traditional check, and can access their benefits quicker as the card can be used immediately without having to go to a bank and cash or deposit a check first.

However, while these agencies provide helpful benefits to recipients, agencies are often unaware of how these benefits are used after they are disbursed. Data regarding the use of benefits may be useful in identifying fraudulent recipients, in improving benefits, in making decisions regarding disbursement amounts, and more. The data may also be useful to third parties, such as non-profit organizations seeking to provide assistance to benefits recipients. However, many benefits agencies are unable to identify how recipients use their benefits money once it has been received and may be restricted as to identifying account numbers for third party analysis.

Thus, there is a need for a technical solution for identifying payment accounts associated with agency entitlements.

### SUMMARY

The present disclosure provides a description of systems and methods for the identification of agency entitlements.

A method for identifying agency entitlements includes: storing, in a transaction database, a plurality of transaction data entries, wherein each transaction data entry includes data related to a payment transaction including at least a specific account identifier associated with a payment account involved in the payment transaction and transaction data; storing, in an account database, a plurality of account profiles, wherein each account profile includes data related to a payment account including at least an account identifier associated with the related payment account and account data; identifying, by a processing device, one or more entitlement rules, wherein each of the one or more entitlement rules is associated with an agency entitlement and is configured to identify recipients of the associated agency entitlement; applying, to account profiles stored in the account database, at least one of the identified one or more entitlement rules to (i) the account identifier and/or account data included in the respective account profile, and/or (ii) the transaction data included in transaction data entries of the plurality of transaction data entries where the included specific account identifier corresponds to the account identifier included in the respective account profile, to identify an agency entitlement associated with the related payment account; and updating, in the account database, account profiles to include the identified agency entitlement associated with the related payment account.

A system for identifying agency entitlements includes a transaction database, an account database, and a processing device. The transaction database is configured to store a plurality of transaction data entries, wherein each transaction data entry includes data related to a payment transaction including at least a specific account identifier associated with a payment account involved in the payment transaction and transaction data. The account database is configured to store a plurality of account profiles, wherein each account profile includes data related to a payment account including at least an account identifier associated with the related payment account and account data. The processing device is configured to: identify one or more entitlement rules, wherein each of the one or more entitlement rules is associated with an agency entitlement and is configured to identify recipients of the associated agency entitlement; applying, to account profile stored in the account database, at least one of the identified one or more entitlement rules to (i) the account identifier and/or account data included in the respective account profile, and/or (ii) the transaction data included in each transaction data entry of the plurality of transaction data entries where the included specific account identifier corresponds to the account identifier included in the respective account profile, to identify an agency entitlement associated with the related payment account; and update, in the account database, account profile to include the identified agency entitlement associated with the related payment account.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying agency entitlements in accordance with exemplary embodiments.

FIG. 2 is a block diagram illustrating the processing server of FIG. 1 for the identification of payment accounts associated with agency entitlements in accordance with exemplary embodiments.

FIG. 3 is a flow diagram illustrating a high level process for identifying agency entitlements using the system of FIG. 1 accordance with exemplary embodiments.

FIG. 4 is a flow diagram illustrating a process for identifying agency entitlements using the processing server of FIG. 2 in accordance with exemplary embodiments.

FIG. 5 is a flow chart illustrating a method for calculating and providing analytics regarding agency entitlements in accordance with exemplary embodiments.

FIG. 6 is a flow chart illustrating a method for analyzing transaction data for a payment account associated with agency entitlements in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Identifying Agency Entitlements

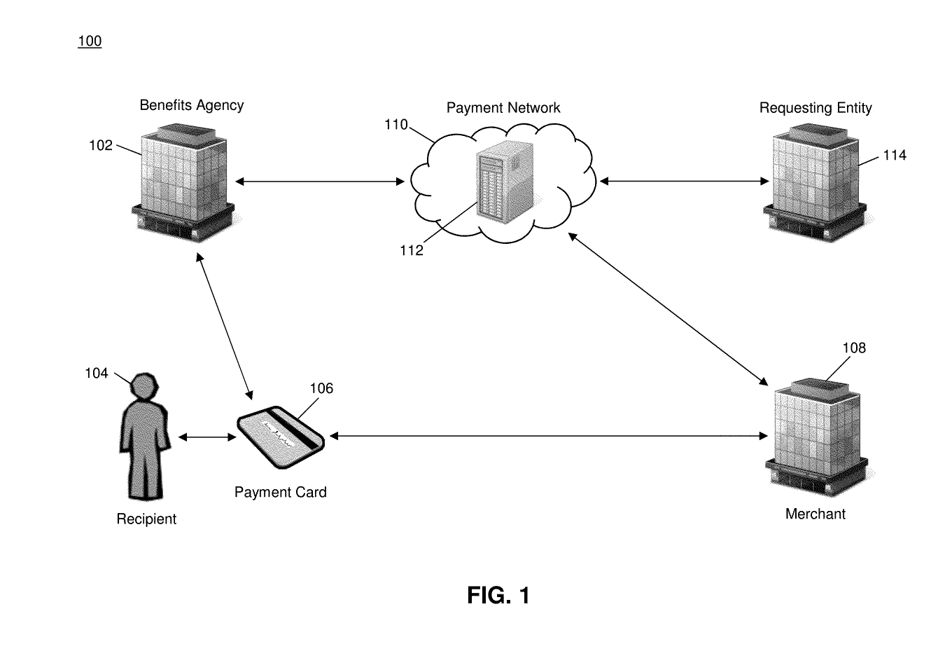

FIG. 1 illustrates a system 100 for the identification of payment accounts funded via agency entitlements.

The system 100 may include a benefits agency 102. The benefits agency 102 may be any type of agency, such as a government agency, a private agency, a for-profit agency, a non-profit agency, etc. that distributes benefits to one or more recipients 104. The benefits agency 102 may distribute benefits to one or more recipients 104 via payment cards 106. A payment card 106 may be distributed to a recipient 104 and may be loaded with or otherwise have access to an amount of funds corresponding to the benefit disbursed to the recipient 104.

The recipient 104 may then use the payment card 106 to conduct payment transactions with merchants 108. In some instances, use of the payment card 106 may be limited to specific merchants 108 and/or specific products purchased at merchants 108. For example, the benefits agency 102 may set limits on what type of products may be purchased by the recipient 104 using the issued payment card 106 as terms of the disbursement. As part of processing these transactions, the merchant 108, or a financial institution on behalf of the merchant 108 (e.g., an acquirer) may submit transaction data in the form of an authorization request to a payment network 110.

The payment network 110 may be configured to process the payment transaction using systems and methods that will be apparent to persons having skill in the relevant art. Transaction data for the payment transaction may be stored locally in a processing server 112. The processing server 112, as discussed in more detail below, may store account profiles regarding payment accounts, such as associated with the payment card 106, and may store the transaction data in a corresponding account profile. As also discussed in more detail below, the processing server 112 may be configured to identify the type of entitlement that is disbursed to the recipient 104 based on data associated with the payment account and/or the transaction data of payment transactions involving the payment account. In an exemplary embodiment, the processing server 112 may be configured to identify the type of entitlement without requiring use of and/or accessing any personally identifiable information of the recipient 104 associated with the account.

In some embodiments, the system 100 may include a requesting entity 114. The requesting entity 114 may submit a request for entitlement data to the processing server 112. The request may be a request for account data associated with recipients 104 of a particular entitlement, a request for analytics of accounts associated with recipients 104 of a particular entitlement, a request for types of entitlements distributed to specific recipients 104, or any other type of request that may be fulfilled by the processing server 112 using the methods disclosed herein as will be apparent to persons having skill in the relevant art. In some embodiments, the requesting entity 114 may be the benefits agency 102. For example, the benefits agency 102 may request analytics on the spending of their recipients 104.

The processing server 112 may then identify the data requested by the requesting entity 114 using the methods disclosed herein and discussed in more detail below. Once the data has been identified, a response to the request may be submitted to the requesting entity 114 that includes the identified data.

### Processing Server

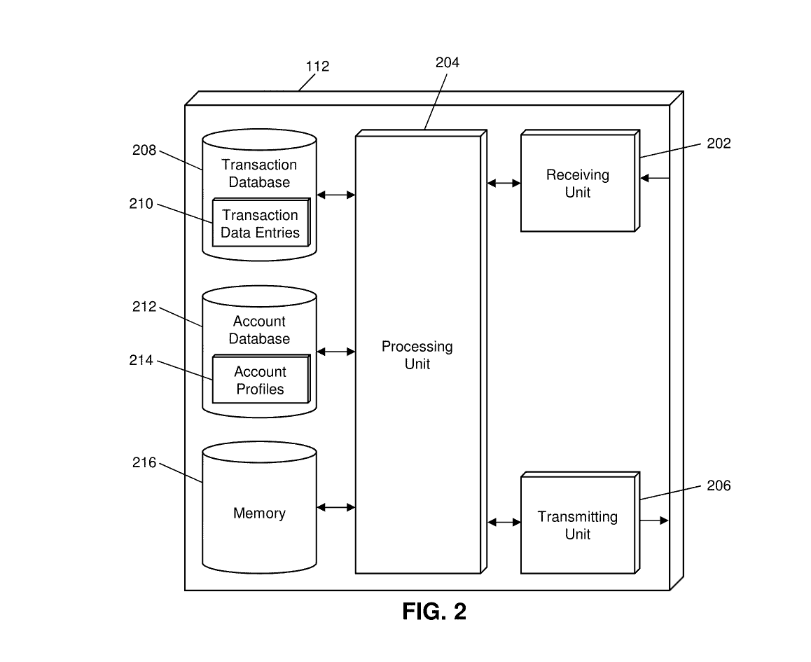

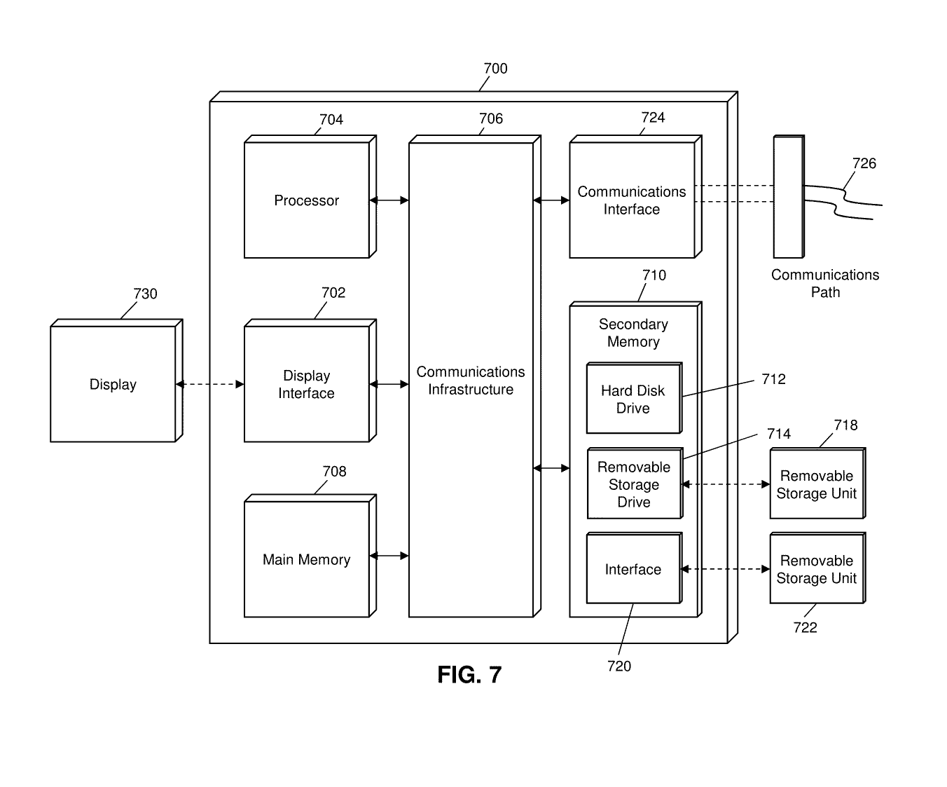

FIG. 2 illustrates an embodiment of the processing server 112 of the system 100. It will be apparent to persons having skill in the relevant art that the embodiment of the processing server 112 illustrated in FIG. 2 is provided as illustration only and may not be exhaustive to all possible configurations of the processing server 112 suitable for performing the functions as discussed herein. For example, the computer system 700 illustrated in FIG. 7 and discussed in more detail below may be a suitable configuration of the processing server 112.

The processing server 112 may include a receiving unit 202. The receiving unit 202 may be configured to receive data over one or more networks via one or more network protocols. The receiving unit 202 may receive data for a plurality of payment transactions, such as payment transactions conducted with one or more payment cards 106 that are issued to recipients 104 of benefits by one or more benefits agencies 102. The data may be stored in a transaction database 208 as a plurality of transaction data entries 210.

Each transaction data entry 210 may include data related to a payment transaction including at least a specific account identifier associated with a payment account involved in the payment transaction, such as a payment account associated with an issued payment card 106, and transaction data. The transaction data may include any data corresponding to the related payment transaction suitable for performing the functions disclosed herein, such as a transaction amount, transaction time and/or date, geographic location, point of sale data, merchant data, product data, consumer data, etc.

The processing server 112 may also include an account database 212. The account database 212 may be configured to store a plurality of account profiles 214. Each account profile 214 may be configured to store data related to a payment account, such as a payment account associated with an issued payment card 106, and may include at least an account identifier associated with the related payment account and account data. The account identifier may be a unique value suitable for identification of the respective account profile 214 and/or associated payment account, such as a payment account number, identification number, etc. The account data may include any additional data corresponding to the related payment account suitable for performing the functions disclosed herein, such as demographic characteristics of the associated recipient 104, disbursement dates, disbursement amounts, transaction analytics, geographic location, etc.

The processing server 112 may also include a processing unit 204. The processing unit 204 may be configured to perform the functions disclosed herein of the processing server 112. The processing unit 204 may identify one or more entitlement rules that may be associated with an agency entitlement, which may be used to identify recipients 104 of the associated agency entitlement. The entitlement rules may be stored in a memory 216 of the processing server 112, which may be configured to store any additional data suitable for performing the functions disclosed herein as will be apparent to persons having skill in the relevant art.

The processing unit 204 may be further configured to apply the entitlement rules to account profiles 214 stored in the account database 212 to identify one or more agency entitlements associated with the related payment account. The entitlement rules may be applied to the account data included in the respective account profile 214 and/or to transaction data included in transaction data entries 210 that are associated with the respective account profile 214. Transaction data entries 210 that are associated with the respective account profile 214 may be transaction data entries 210 that included specific account identifier correspond to the account identifier included in the respective account profile 214. Once the agency entitlement or entitlements associated with an account profile 214 have been identified, the processing unit 204 may update the account profile 214 to indicate the associated agency entitlement or entitlements.

In some embodiments, the receiving unit 202 may be configured to receive requests for entitlement data, such as from the requesting entity 114. The request for entitlement data may include at least a specific agency entitlement and one or more requested analytics. The processing unit 204 may be configured to identify account profiles 214 in the account database 212 that are associated with the specific agency entitlement, and then may calculate the one or more requested analytics based on the included account data and/or the transaction data included in associated transaction data entries 210. In some embodiments, the request for entitlement data may be a request for identification of agency entitlements associated with specific recipients 104. In such an embodiment, the processing unit 204 may identify account profiles 214 that are associated with the specific recipients 104 and the agency entitlement indicated therein.

Once the requested data has been identified, a transmitting unit 206 of the processing server 112 may be configured to transmit the requested data as a response to the received request for entitlement data. The transmitting unit 206 may be configured to transmit data, such as the response, over one or more networks via one or more network protocols.

### Process for Identifying Agency Entitlements

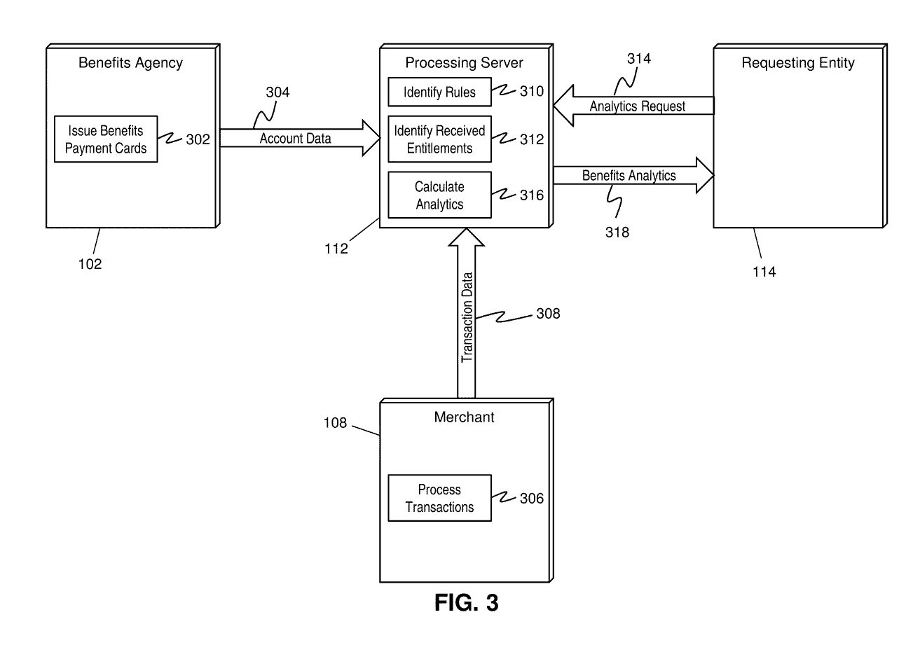

FIG. 3 illustrates a process for identifying agency entitlements using the system 100 of FIG. 1.

In step 302, the benefits agency 102 may issue payment cards 106 to benefits recipients 104. Each payment card 106 may be associated with an entitlement and may be funded accordingly by the benefits agency 102. In step 304, account data associated with the issued payment cards 106 may be transmitted to the processing server 112 and received by the receiving unit 202 of the processing server 112, although this step is not required as explained below. The processing unit 204 may store the received account data in the account database 212 as a plurality of account profiles 214.

In step 306, the merchant 108 may conduct payment transactions funded by the issued payment cards 106. As part of the conducting of the payment transactions, the transaction may be processed by the payment network 110 and, in step 308, data for the transaction may be transmitted to the processing server 112 and received by the receiving unit 202. The processing unit 204 may store the received data in the transaction database 208 as a plurality of transaction data entries 210.

In step 310, the processing unit 204 may identify entitlement rules stored in the memory 216. The processing unit 204 may then, in step 312, apply the entitlement rules to the account data stored in the account profiles 214 of the account database 212 and/or the transaction data stored in the transaction data entries 210 of the transaction database 208. In some embodiments, the processing unit 204 may also update the account profiles 214 to indicate the identified entitlements received by the related payment accounts.

The entitlement rules that are used to identify entitlements distributed to a payment account via a payment card 106 may include rules regarding bank identification number (BIN) ranges, issuers, purchased products, transaction limits, account limits, and time and/or date ranges. For example, payment cards 106 associated with a specific entitlement may always be issued with a specific BIN or within a range of BINs, and therefore the processing unit 204 may identify an account with a payment card number with that BIN or in the range of BINs as being associated with the corresponding entitlement. In another example, a specific entitlement may always be disbursed on the same day of the month and for the same value, and therefore accounts with disbursement dates and disbursement amounts of that same value may be identified as recipients of that entitlement.

In yet another example, a specific entitlement may only be used to purchase specific types of products. The processing unit 204 may identify the transaction data for payment transactions conducted using a payment card 106, which may indicate that only those specific types of products are purchased, which may further indicate that the payment card 106 and associated payment account are tied to that specific entitlement.

In step 314, the requesting entity 114 may transmit a request for analytics to the processing server 112, which may be received by the receiving unit 202. In step 316, the processing unit 204 may identify account profiles 214 corresponding to the request for analytics, and may calculate the requested analytics based on the account data included in the identified account profiles 214 and/or the transaction data included in associated transaction data entries 210. In step 318, the transmitting unit 206 of the processing server 112 may transmit the calculated analytics to the requesting entity in response to the received request.

### Process for Calculating Entitlement Analytics

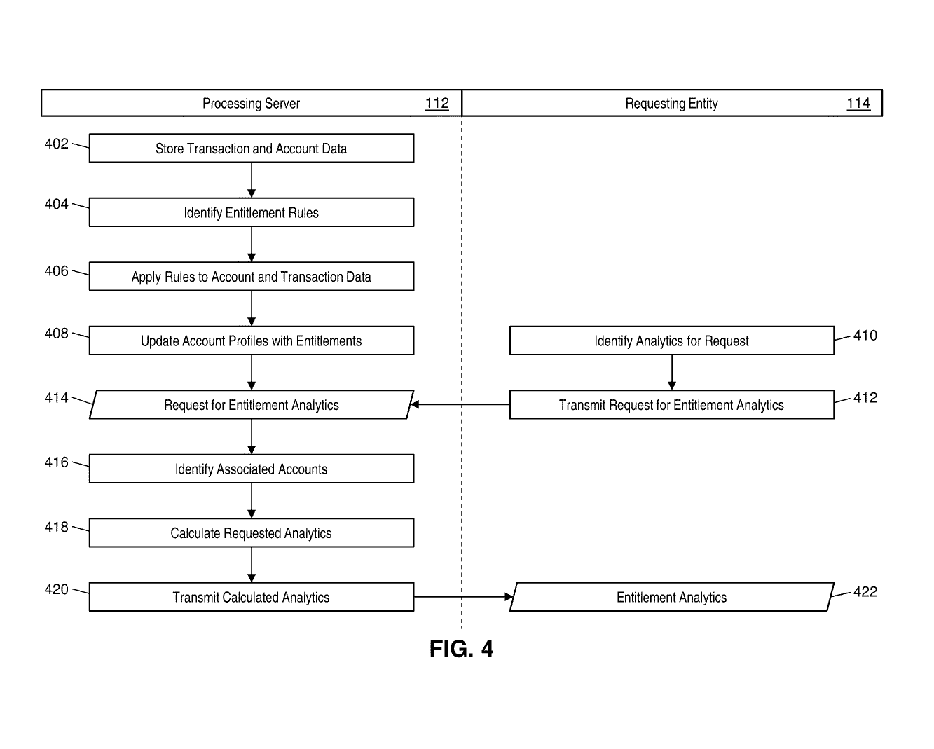

FIG. 4 illustrates a process for calculating and providing analytics regarding agency entitlements by the processing server 112.

In step 402, the processing unit 204 of the processing server 112 may store transaction and account data in the transaction database 208 and account database 212, respectively. The transaction data may be stored as a plurality of transaction data entries 210 in the transaction database 208, and the account data may be stored as a plurality of account profiles 214 in the account database 212. In step 404, the processing unit 204 may identify entitlement rules stored in the memory 216 to be used to identify recipients 104 of associated agency entitlements.

In step 406, the processing unit 204 may apply the identified entitlement rules to each of the account profiles 214 to identify an associated entitlement based on application of the rules to the account identifier and/or account data included in the respective account profile 214 and/or the transaction data included in each transaction data entry 210 that includes a specific account identifier corresponding to the account identifier included in the respective account profile 214. In step 408, the processing unit 204 may update each account profile 214 to indicate the identified agency entitlement associated with the account profile 214.

In step 410, the requesting entity 114 may identify analytics for requesting. The analytics may include spending behaviors, propensity to spend, transaction frequency, transaction areas, geography of spending, product spending, entitlements received, etc. In step 412, the requesting entity 114 may transmit a request for the identified analytics to the processing server 112. In step 414, the receiving unit 202 of the processing server 112 may receive the request for analytics.

In step 416, the processing unit 204 of the processing server 112 may identify account profiles 214 in the account database 212 that are associated with an agency entitlement as indicated in the request for analytics. In step 418, the processing unit 204 of the processing server 112 may calculate the requested analytics based on the account data included in the identified account profiles 214 and/or the transaction data included in transaction data entries 210 associated with each identified account profile 214 where the specific account identifier included in the transaction data entry 210 corresponds to the account identifier included in the respective identified account profile 214.

In step 420, the transmitting unit 206 of the processing server 112 may transmit the calculated analytics to the requesting entity 114 as a response to the earlier received request for analytics. In step 422, the requesting entity 114 may receive the calculated entitlement analytics.

### Exemplary Method for Identifying Agency Entitlements

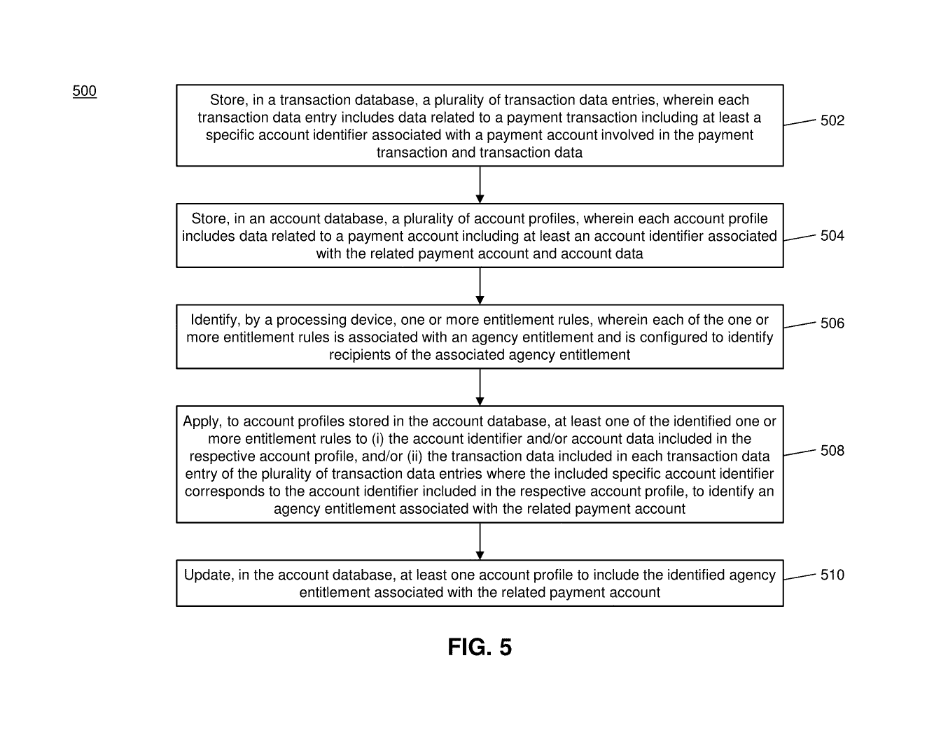

FIG. 5 illustrates a method 500 for the identification of agency entitlements.

In step 502, a plurality of transaction data entries (e.g., transaction data entries 210) may be stored in a transaction database (e.g., the transaction database 208), wherein each transaction data entry 210 includes data related to a payment transaction including at least a specific account identifier associated with a payment account involved in the payment transaction and transaction data. In one embodiment, the transaction data may include at least one of: merchant data, product data, transaction time and/or date, transaction amount, and geographic location.

In step 504, a plurality of account profiles (e.g., account profiles 214) may be stored in an account database (e.g., the account database 212), wherein each account profile 214 includes data related to a payment account including at least an account identifier associated with the related payment account and account data. In one embodiment, the account data may include at least one of: a bank identification number, issuer data, a deposit date, a withdrawal date, a deposit amount, a transaction limit, one or more limitations on use, a geographic location, and demographics data.

In step 506, one or more entitlement rules may be identified by a processing device (e.g., the processing unit 204), wherein each of the one or more entitlement rules is associated with an agency entitlement and is configured to identify recipients (e.g., recipients 104) of the associated agency entitlement. In one embodiment, the agency entitlement may be at least one of: social security, welfare, unemployment, disability, and veteran's benefits. In some embodiments, the one or more entitlement rules may include at least one of: a bank identification number range, a list of issuers, a list of products, transaction limits, account limits, and a time and/or date range.

In step 508, each of the identified one or more entitlement rules may be applied to each account profile 214 stored in the account database 212 by application of each of the identified one or more entitlement rules to (i) the account identifier and/or account data included in the respective account profile 214, and/or (ii) the transaction data included in each transaction data entry 210 of the plurality of transaction data entries 210 where the included specific account identifier corresponds to the account identifier included in the respective account profile 214, to identify an agency entitlement associated with the related payment account. In step 510, each account profile 214 in the account database 212 may be updated to include the identified agency entitlement associated with the related payment account.

### Exemplary Method for Calculating Entitlement Analytics

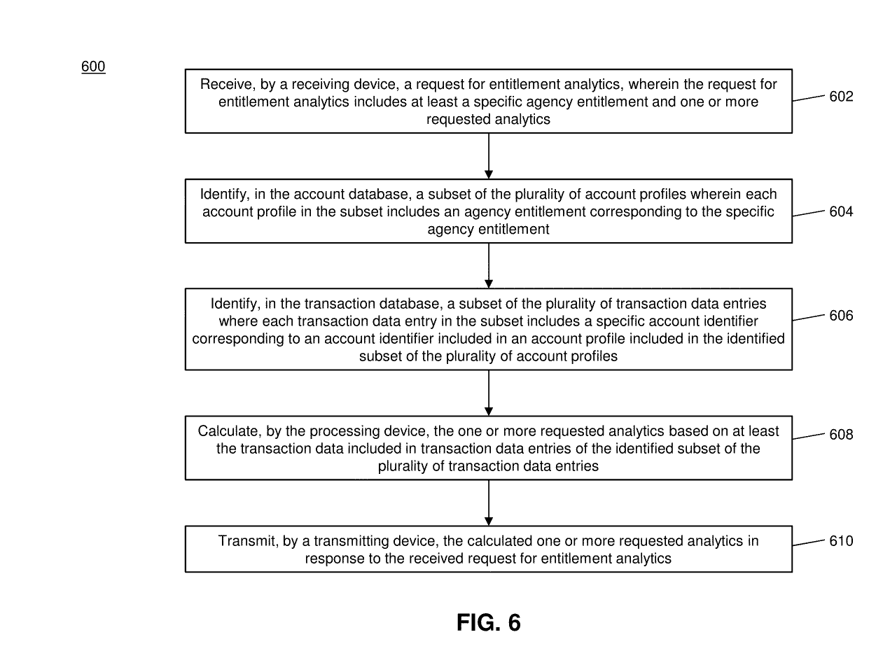

FIG. 6 illustrates a method 600 for the calculating and providing of entitlement analytics based on transaction data. In some embodiments, the steps of the method 600 as discussed herein may be executed in combination with the steps of the method 500, such as for calculating analytics based on the agency entitlements identified in the method 500.

In step 602, a request for entitlement analytics may be received by a receiving device (e.g., the receiving unit 202), wherein the request for entitlement analytics includes at least a specific agency entitlement and one or more requested analytics. In one embodiment, the one or more requested analytics may include at least one of: spending behavior, propensity to spend, transaction frequency, transaction area, and product spending.

In step 604, a subset of the plurality of account profiles 214 may be identified in the account database 212, wherein each account profile 214 in the subset includes an agency entitlement corresponding to the specific agency entitlement. In step 606, a subset of the plurality of transaction data entries 210 may be identified in the transaction database 208 where each transaction data entry 210 in the subset includes a specific account identifier corresponding to an account identifier included in an account profile 214 included in the identified subset of the plurality of account profiles 214.

In step 608, the one or more requested analytics may be calculated by the processing unit 204 based on at least the transaction data included in each transaction data entry 210 of the identified subset of the plurality of transaction data entries 210. In step 610, the calculated one or more requested analytics may be transmitted, by a transmitting device (e.g., the transmitting unit 206), in response to the received request for entitlement analytics.

### Computer System Architecture

FIG. 7 illustrates a computer system 700 in which embodiments of the present disclosure, or portions thereof, may be implemented as computer-readable code. For example, the processing server 112 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying agency entitlements. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying agency entitlements, comprising:
storing, in a transaction database, a plurality of transaction data entries, wherein each transaction data entry includes data related to a payment transaction including at least a specific account identifier associated with a payment account involved in the payment transaction and transaction data;
storing, in an account database, a plurality of account profiles, wherein each account profile includes data related to a payment account including at least an account identifier associated with the related payment account and account data;
identifying, by a processing device, one or more entitlement rules, wherein each of the one or more entitlement rules is associated with an agency entitlement and is configured to identify recipients of the associated agency entitlement;
applying, to account profiles stored in the account database, at least one of the identified one or more entitlement rules to (i) the account identifier and/or account data included in the respective account profile, and/or (ii) the transaction data included in transaction data entries of the plurality of transaction data entries where the included specific account identifier corresponds to the account identifier included in the respective account profile, to identify an agency entitlement associated with the related payment account; and
updating, in the account database, account profiles to include the identified agency entitlement associated with the related payment account.

2. The method of claim 1, further comprising:
receiving, by a receiving device, a request for entitlement analytics, wherein the request for entitlement analytics includes at least a specific agency entitlement and one or more requested analytics;
identifying, in the account database, a subset of the plurality of account profiles wherein each account profile in the subset includes an agency entitlement corresponding to the specific agency entitlement;
identifying, in the transaction database, a subset of the plurality of transaction data entries where each transaction data entry in the subset includes a specific account identifier corresponding to an account identifier included in an account profile included in the identified subset of the plurality of account profiles;
calculating, by the processing device, the one or more requested analytics based on at least the transaction data included in the identified subset of the plurality of transaction data entries; and
transmitting, by a transmitting device, the calculated one or more requested analytics in response to the received request for entitlement analytics.

3. The method of claim 1, wherein the agency entitlement is at least one of: social security, welfare, unemployment, disability, and veteran's benefits.

4. The method of claim 1, wherein the account data includes at least one of: a bank identification number, issuer data, a deposit date, a withdrawal date, a deposit amount, a transaction limit, one or more limitations on use, a geographic location, and demographics data.

5. The method of claim 1, wherein the transaction data includes at least one of: merchant data, product data, transaction time and/or date, transaction amount, and geographic location.

6. The method of claim 2, wherein the one or more requested analytics includes at least one of: spending behavior, propensity to spend, transaction frequency, transaction area, and product spending.

7. The method of claim 1, wherein the one or more entitlement rules includes at least one of: a bank identification number range, a list of issuers, a list of products, transaction limits, account limits, and a time and/or date range.

8. The method of claim 1, wherein the account data does not include any personally identifiable information.

9. A system for identifying agency entitlements, comprising:
a transaction database configured to store a plurality of transaction data entries, wherein each transaction data entry includes data related to a payment transaction including at least a specific account identifier associated with a payment account involved in the payment transaction and transaction data;
an account database configured to store a plurality of account profiles, wherein each account profile includes data related to a payment account including at least an account identifier associated with the related payment account and account data; and
a processing device configured to
identify one or more entitlement rules, wherein each of the one or more entitlement rules is associated with an agency entitlement and is configured to identify recipients of the associated agency entitlement,
applying, to account profile stored in the account database, at least one of the identified one or more entitlement rules to (i) the account identifier and/or account data included in the respective account profile, and/or (ii) the transaction data included in each transaction data entry of the plurality of transaction data entries where the included specific account identifier corresponds to the account identifier included in the respective account profile, to identify an agency entitlement associated with the related payment account, and
update, in the account database, account profile to include the identified agency entitlement associated with the related payment account.

10. The system of claim 9, further comprising:
a transmitting device; and
a receiving device configured to receive a request for entitlement analytics, wherein the request for entitlement analytics includes at least a specific agency entitlement and one or more requested analytics, wherein
the processing device is further configured to
identify, in the account database, a subset of the plurality of account profiles wherein each account profile in the subset includes an agency entitlement corresponding to the specific agency entitlement,
identify, in the transaction database, a subset of the plurality of transaction data entries where each transaction data entry in the subset includes a specific account identifier corresponding to an account identifier included in an account profile included in the identified subset of the plurality of account profiles, and
calculate the one or more requested analytics based on at least the transaction data included in each transaction data entry of the identified subset of the plurality of transaction data entries, and
the transmitting device is configured to transmit the calculated one or more requested analytics in response to the received request for entitlement analytics.

11. The system of claim 9, wherein the agency entitlement is at least one of: social security, welfare, unemployment, disability, and veteran's benefits.

12. The system of claim 9, wherein the account data includes at least one of: a bank identification number, issuer data, a deposit date, a withdrawal date, a deposit amount, a transaction limit, one or more limitations on use, a geographic location, and demographics data.

13. The system of claim 9, wherein the transaction data includes at least one of: merchant data, product data, transaction time and/or date, transaction amount, and geographic location.

14. The system of claim 10, wherein the one or more requested analytics includes at least one of: spending behavior, propensity to spend, transaction frequency, transaction area, and product spending.

15. The system of claim 9, wherein the one or more entitlement rules includes at least one of: a bank identification number range, a list of issuers, a list of products, transaction limits, account limits, and a time and/or date range.

16. The system of claim 9, wherein the account data does not include any personally identifiable information.
